(19) United States
(12) Patent Application Publication
(10) Pub. No.: US 2011/0231055 A1
(43) Pub. Date: Sep. 22, 2011

(54) MAINTENANCE SYSTEM AND METHOD FOR VEHICLE FLEETS

(75) Inventors: Marc KNIGHT, Parkesburg, PA (US); Michael BRITTINGHAM, Phoenixville, PA (US); Paul ERNSDORFF, Spokane, WA (US)

(73) Assignee: ASSETWORKS INC., Wayne, PA (US)

(21) Appl. No.: 13/050,556

(22) Filed: Mar. 17, 2011

Related U.S. Application Data
(60) Provisional application No. 61/315,244, filed on Mar. 18, 2010.

(51) Int. Cl. G06F 7/00

(52) U.S. Cl. 701/33; 701/1

(57) ABSTRACT

A system and method for managing a fleet of vehicles including a control unit on one or more vehicles in the fleet of vehicles, a data collection unit on one or more vehicles in the fleet of vehicles in communication with the control unit, a server having an operational database for receiving data from one of the control unit and the data collection unit, and a telemetry module having access to the operational database for initiating an action based on an analysis of data on the server.

This application claims priority to U.S. Provisional Application No. 61/315,244, the contents of which are herein expressly incorporated by reference.

### FIELD OF THE INVENTION

The present invention relates to the field of automotive fleet management methods and systems, and more specifically, to a telemetric system to facilitate maintenance of vehicles within a fleet.

### BACKGROUND OF THE INVENTION

Telemetry is broadly defined as the science of sending, receiving and storing information via telecommunication devices. The term later evolved to include automation in automobiles, such as emergency warning systems for vehicles. In this application, the term telemetry, and variations thereof, will refer generally to the use of the aforementioned technology in the automotive, and transportation fields. It is known in the art to collect various telemetric data for vehicles including odometer readings, global positioning systems (GPS) positions, diagnostic codes, and vehicle measurements. In the past, this data has been collected and used for statistical analyses for operations.

Historically, individual vehicles within fleets, for example fleets of commercial or public sector vehicles, were monitored and periodically manually checked to determine the appropriate times for scheduled or unscheduled maintenance, either by noting the odometer readings, or upon inspection of various parts of the vehicle. This often led to delays in ensuring proper maintenance and more of a reactive approaching to vehicle maintenance based on human-identified problems with the vehicle.

There is a need in the art for improved methods and systems related to fleet management in order to mitigate one or more of the aforementioned problems in the art.

### SUMMARY OF THE INVENTION

In accordance with one embodiment of the invention, there is provided a system for managing a fleet of vehicles including a control unit on one or more vehicles in the fleet of vehicles, a data collection unit on one or more vehicles in the fleet of vehicles in communication with the control unit, a server having an operational database for receiving data from one of the control unit and the data collection unit, a telemetry module having access to the operational database for initiating an action based on an analysis of data on the server.

According to one aspect of the invention, the telemetry module is provided on the server. Alternatively, the telemetry module may be provided on a computer system in wireless communication with the server.

According to another aspect of the invention, there is provided one or more sensors on one or more vehicles in the fleet of vehicles. The sensors are preferably in communication with the control unit. Preferably, the sensors include means to measure at least one vehicle parameter selected from the group comprising an odometer reading, fuel level, engine status, vehicle speed, vehicle location, system pressure, vehicle emissions, vehicle power status, vehicle idle status, engine diagnostic trouble codes, vehicle acceleration and vehicle engine parameters.

According to another aspect of the invention, the system further includes one or more service provider modules on one or more service provider computer systems. The telemetry module is adapted to communicate with the one or more service provider computer systems, whereby a service provider carries out the action initiated by the telemetry module.

According to another aspect of the invention, the system includes a data collection terminal located proximate a location where the one or more vehicles in the fleet of vehicles is parked. The data collection terminal may include wireless data communication means for communication with the control unit, such as a radio frequency communication device. Preferably, the data collection terminal is adapted to collect data from the data collection unit.

Preferably, the action initiated by the telemetry module is a maintenance action, and more preferably, a conditional maintenance action.

According to another embodiment of the invention, there is provided a method for managing a fleet of vehicles including providing a control unit on one or more vehicles in the fleet of vehicles, providing a data collection unit on one or more vehicles in the fleet of vehicles in communication with the control unit, receiving data from one of the control unit and the data collection unit and storing the data on an operational database, accessing the operational database via a telemetry module, and initiating an action based on an analysis of data on said operational database.

According to one aspect of this embodiment, the telemetry module is provided on said server. According to another aspect, the telemetry module is provided on a computer system in wireless communication with said server.

According to another aspect of this embodiment, there is provided one or more sensors on the one or more vehicles in the fleet of vehicles. The one or more sensors are preferably in communication with the control unit. The method preferably further includes measuring at least one vehicle parameter with the at least one sensor, where the parameter may be selected from the group comprising an odometer reading, fuel level, engine status, vehicle speed, vehicle location, system pressure, vehicle emissions, vehicle power status, vehicle idle status, engine diagnostic trouble codes, vehicle acceleration and vehicle engine parameters.

According to another aspect of this embodiment, the method further includes providing one or more service provider modules on one or more service provider computer systems, and the telemetry module is adapted to communicate with the one or more service provider computer systems. In this aspect, the step of initiating is carried out by the one or more service provider modules.

According to another aspect of this embodiment, the method includes providing a data collection terminal proximate a location where the one or more vehicles in the fleet of vehicles is parked. Preferably, the data collection terminal includes wireless data communication means for communicating with the control unit, and the method further includes the step of collecting data at said data collection terminal from said data collection unit.

### BRIEF DESCRIPTION OF THE DRAWINGS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only, and are not intended as a definition of the limits of the invention. In the accompanying drawings:

FIG. 1 shows a system level view of one embodiment of the invention.

FIG. 2 shows a computer system for implementing certain aspects of the invention.

FIG. 3 is a schematic view of elements of the invention as installed on vehicles in the fleet of FIG. 1.

FIG. 4 is a system level view showing additional aspects of the invention.

FIG. 5 shows a representative data collection terminal for use with the system of FIG. 4 in passive mode communications.

### DETAILED DESCRIPTION OF THE PREFERRED EMBODIMENTS

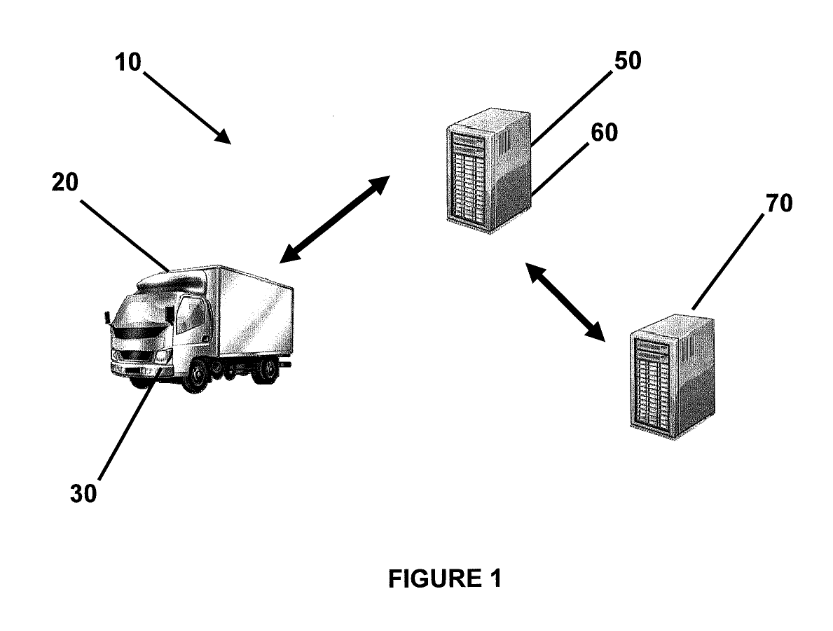

Referring now to FIG. 1, there is shown one embodiment of the invention in which there is generally provided a system 10 for managing a fleet of vehicles 20 including a control unit 30 on one or more vehicles in the fleet of vehicles, a data collection unit 40 on one or more vehicles in the fleet of vehicles in communication with the control unit 30, a server 50 having an operational database 60 for receiving data from one of the control unit 30 and the data collection unit 40, and a telemetry module 70 having access to the operational database 60 for initiating an action based on an analysis of data on the server 50.

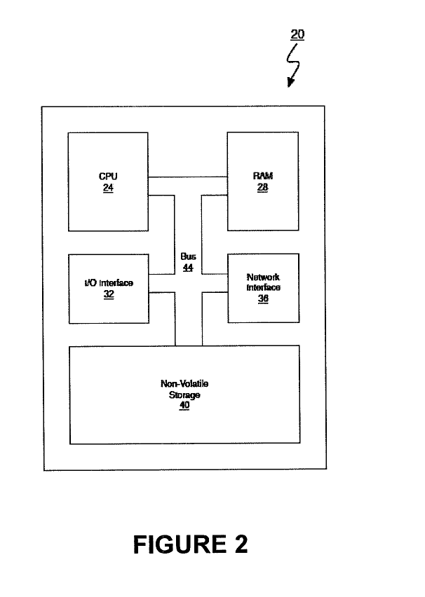

The control unit 30 is preferably an onboard computer system provided on each vehicle. Such a computer system may include, as shown in FIG. 2, a number of physical and logical components, including a central processing unit (“CPU”) 24, random access memory (“RAM”) 28, an input/output (“I/O”) interface 32, a network interface 36, non-volatile storage 4, and a local bus 44 enabling the CPU 24 to communicate with the other components. The CPU 24 executes an operating system, and a number of software systems and/or software modules. RAM 28 provides relatively-responsive volatile storage to the CPU 24. The I/O interface 32 allows for input to be received from one or more devices, such as a keyboard, a mouse, etc., and outputs information to output devices, such as a display and/or speakers. The network interface 36 permits communication with other elements of the invention described herein as being in networked communication with each other. Non-volatile storage 4 stores the operating system and programs. During operation of the computer system, the operating system, the programs and the data may be retrieved from the non-volatile storage 4 and placed in RAM 28 to facilitate execution.

The data collection unit 40 may also be computer system in accordance with that described above and adapted to receive and store data from one or more sensors on each vehicle, or from other vehicle data sources, as will be described in more detail below. The server 50 preferably includes non-volatile storage means on where the operational database 60 is stored to maintain data from each of the vehicles in the fleet. The telemetry module 70 may also be located on the server, but may, alternatively, be located on another computer system having communication access to the server 50. Various other elements of the preferred embodiments of the invention as will be described in more detail hereinbelow may be implemented on a computer system having some or all of the components described with respect to FIG. 2, above.

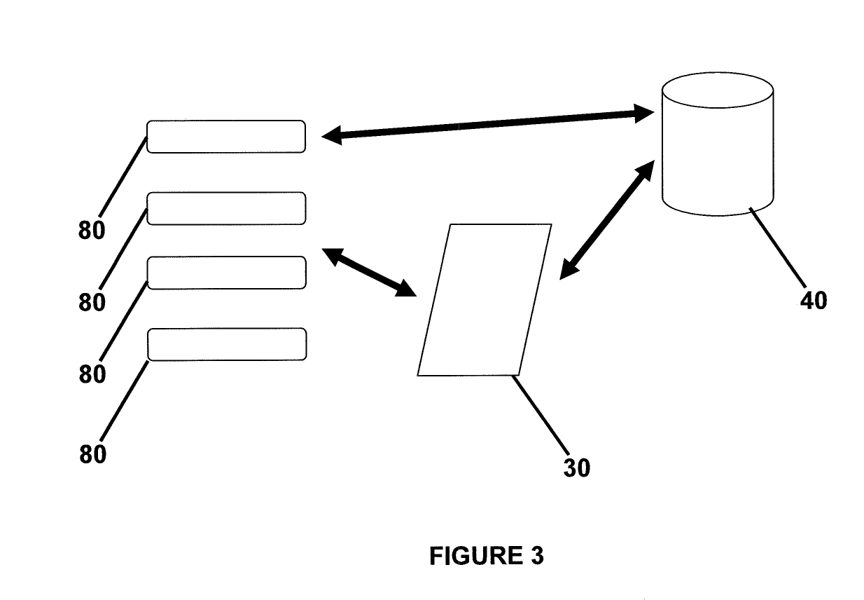

Referring now to FIG. 3, there is shown a schematic representation of a preferred embodiment of a control unit 30 as will be provided on one or more vehicles in the fleet. The control unit 30 is preferably part of, or in and of itself, an on-board computer on each vehicle. The control unit 30 may variably be referred to as an engine control unit 30 and is adapter to manage vehicle performance, and capture vehicle operating parameters from one or more sensors 80 provided on each vehicle in the fleet. The vehicle parameters may include one or more of odometer reading, fuel level, engine status, vehicle speed, vehicle location, system pressure, vehicle emissions, vehicle power status, vehicle idle status, engine diagnostic trouble codes, vehicle acceleration and vehicle engine parameters. Preferably, the data captured by the control unit 30 will be stored on the data collection unit 40 in a format suitable for wireless communication. In a preferred embodiment, the data is stored in hexadecimal format and transmitted to the operational database 60 on the server 50 using a standard wireless protocol. The control unit 30 may further provide information related to sensor triggered diagnostic trouble codes, such as fault mode indicators, specific occurrences of vehicle problems and status indicators for various vehicle on-board systems. As will be appreciated by those skilled in the art, any software or module as herein described, such as the telemetry module 70, that is accessing data, will include thereon instructions on converting the data string into a format useable as required, or to otherwise extract only data relevant to a particular operation being performed.

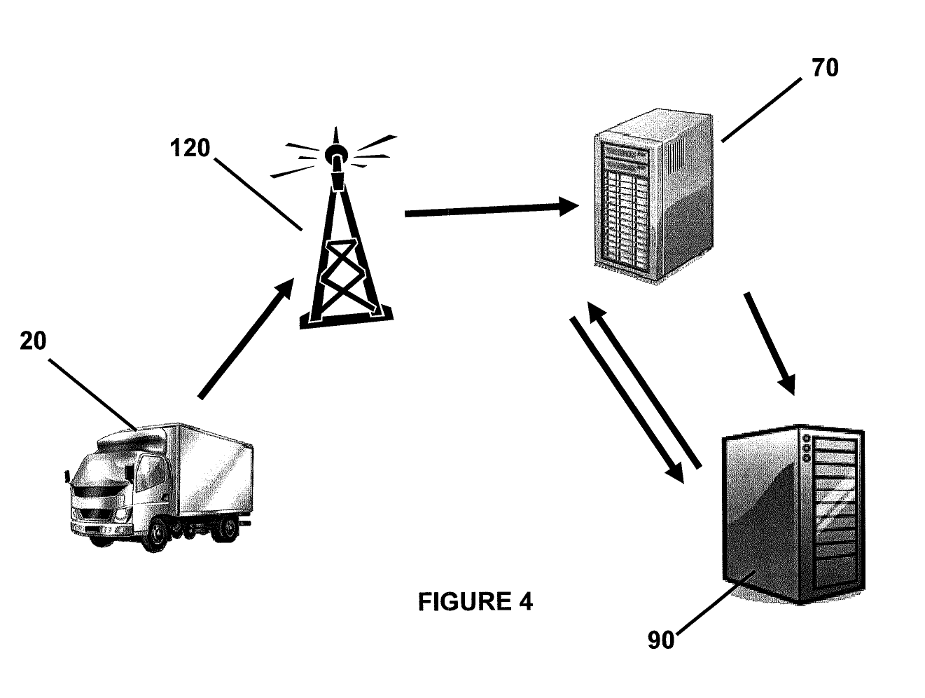

Communication means provided on the control unit 30 may preferably operate in active and passive modes, depending on the location and use of a particular vehicle in the fleet. In the active mode, as shown in FIG. 4, the communications infrastructure preferably uses CDMA/GRPRS modems over a wireless network 120, Local Area Networks (LAN) or alternatively, satellite-based systems for use in remote areas. Communication between the data collection unit and the wireless network is thus always active, or active on predetermined intervals. Two-way communication with components on the vehicle is also possible providing, for example, remote shutdown and vehicle tracking options. Generally, operating in the active mode incurs generally costlier network access charges. Furthermore, the active communication mode allows for two-way communication to, for example, confirm receipt of a problem being logged, or to send out GPS coordinates.

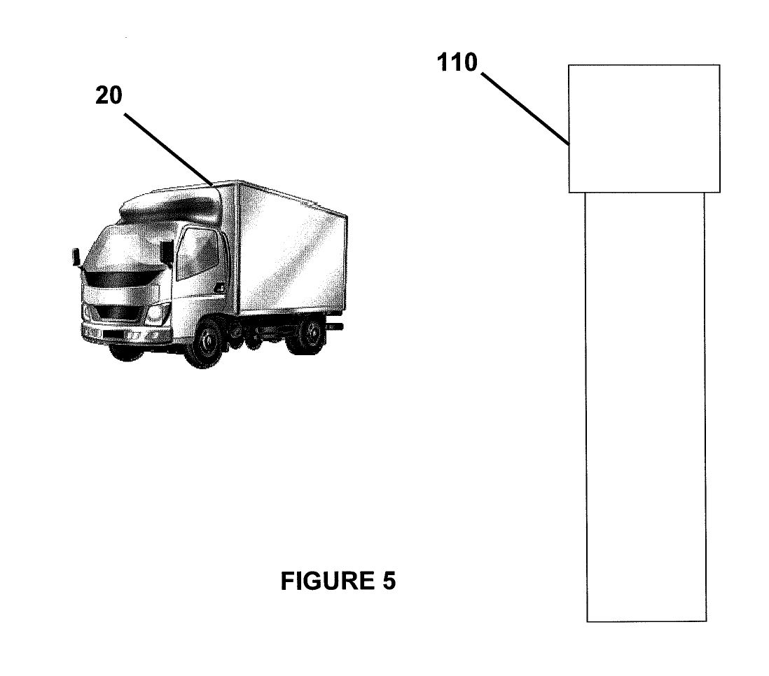

In the passive mode, communication occurs via Wi-Fi, 900 MHz or RFID based networks, for example. Communication is transmitted on an event-based arrangement, such as vehicle on/off, scheduled transmissions, driver triggered communication or proximity to a receiver. Two-way communication is limited in passive mode. On-demand mode functions when there is a direct connection to the vehicle, for example, when used with vehicle diagnostic tools. It is also contemplated that a combination of active and passive communication modes may be used, depending on the nature of the communication. In the passive mode, it is further contemplated that a data collection terminal 110, shown in FIG. 5, is provided and located proximate a location where one or more vehicles in the fleet of vehicles is parked. The control unit 80 is then adapted to collect data from the data collection unit and communicate it to the data collection terminal. In this passive mode, a technician may connect a diagnostic computer to the vehicle and manually reviews vehicle fault codes to identify issues. Optionally, the fault codes can generate predetermined work requests or be linked otherwise to work orders. Once the repair is completed, the technician clears the codes and optionally performs a quality inspections.

The telemetry module 70 is adapted to receive, or otherwise access, data from the control unit and provides for various functions and abilities as will be described in more detail further below. In one embodiment, shown in FIG. 4, the telemetry module 70 communicates with a service provider module 90, stored on a service provider computer system that initiates an action to be carried out with respect to a particular vehicle. For example, the telemetry module 70 may make a determination that a particular type of maintenance is needed on a vehicle and passes this information on to the service provider module 90 which initiates the maintenance being done, for example by sending out a work order. Particular examples of implementation are provided below.

The telemetry module 70 can be used to initiate a number of actions, such as maintenance actions. In the preferred embodiments, the telemetry module 70 further provides the ability for maintenance personnel, for example, to review data from any particular vehicle in the fleet, a group of vehicles in the fleet, or of the fleet as a whole and to further analyze the data or initiate specific actions based on this analysis. The results achieved by the system as herein described allows for improved efficiencies in the management of a large number of vehicles in a fleet.

It will be appreciated by one skilled in the art that the availability of telemetry data and use according to the present invention generally improves fleet management. More specifically, a better picture of vehicle usage and demand may be provided. For example, the telemetry module may analyze the fuel consumption of a particular vehicle in the fleet, a group of vehicles in the fleet and of the entirety of the fleet. In this regard, vehicle performance and driving habits may be optimized to reduce fuel consumption, by, for example, identifying vehicles and driving habits where fuel consumption is above particular benchmark numbers.

In the preferred embodiment, the telemetry module has access to sensor data measure various operating parameters of each and every vehicle, as described above. The telemetry module also has access to vehicle diagnostic codes as output by the engine of each vehicle. With regards to maintenance, unreported problems may be identified before becoming failures, by way of these sensor measurement. Therefore, maintenance schedules and actions can be predicted and performed on a preventative schedule based on an overall fleet schedule. It is also possible to establish condition-based maintenance programs in addition to preventative maintenance programs and to use vehicle performance data to improve warranty coverage and vehicle component selection. The present invention also allows for additional monitoring or driver actions and behavior, for example in monitoring route deviations or collecting operating data to identify poor driving habits. When accidents do occur, collected parameter data may be used to analyze and interpret the vehicle state at the time of the accident. For insurance and regulatory purposes, a log is easily created to show times of service, pre-trip inspections, emissions monitoring and fuel tax reporting.

Furthermore, better operational management of vehicles in the fleets is possible by using GPS tracking and meter data to present a truer picture of vehicle use and demand. Frequent and accurate meter readings are made possible, as are hourly and daily readings to confirm use. The number of vehicle starts and stops and trips made per day may also be monitored.

With such overall fleet management, it will be possible to identify opportunities for vehicle trip sharing, monitoring of unauthorized vehicle use and send alerts when vehicles deviate from a work zone or route.

In terms of fuel management, the system herein described may be used for tracking and tracing of leakage points in fuel consumption, including monitoring engine idle time, monitoring emission/engine parameters to improve performance, monitoring driver behaviour related to an increase in fuel consumption, including high acceleration, speed and hard braking and allows for the tracking of unnecessary miles. This information may then be used to anticipate when a vehicle may be ready for it's next scheduled maintenance and to account for and plan for this maintenance at appropriate times.

The maintenance management functions use vehicle parameters and diagnostic trouble codes to drive maintenance procedures for individual vehicles. Accordingly, immediate action may be taken to fault code alerts and a condition-based maintenance approach may be implemented. For example, alerts may be monitored to schedule service to avoid unreported problems, and the fault codes may be linked to maintenance records. Using a condition-based maintenance approach involves monitoring operating parameter thresholds to trigger maintenance activities and incorporating parameter data into failure analysis to establish flags for future failures. The parameter data may also be incorporated into warranty claims and both parameter and performance data may be used for vehicle and/or component selection purposes.

Accordingly, the complete maintenance cycle of vehicles in a fleet may be monitored, controlled, and documented using the system and method herein described. Various telemetric applications have been described using passive, active or on-demand communication to transmit data relevant for maintenance purposes including generating work requests, viewing historical data and collecting operational data for all vehicles in the fleet.

As will be apparent to those skilled in the art, various modifications and variations to the system and method herein described will be possible, without departing from the spirit of the invention. It will also be apparent to those skilled in the art that the present invention may be used for vehicle rental purposes, vehicle sharing purposes, organizational vehicle control, and provide information and data as required and adapted to each of these types of business.

1. A system for managing a fleet of vehicles comprising:
a control unit on one or more vehicles in the fleet of vehicles;
a data collection unit on one or more vehicles in the fleet of vehicles in communication with said control unit;
a server having an operational database for receiving data from one of said control unit and said data collection unit;
a telemetry module having access to said operational database for initiating an action based on an analysis of data on said server.

2. A system according to claim 1, wherein said telemetry module is provided on said server.

3. A system according to claim 1, wherein said telemetry module is provided on a computer system in wireless communication with said server.

4. A system according to claim 1, further comprising one or more sensors on said one or more vehicles in the fleet of vehicles; said one or more sensors in communication with said control unit.

5. A system according to claim 4, wherein said one or more sensors include means to measure at least one vehicle parameter.

6. A system according to claim 5, wherein said at least one vehicle parameter is selected from the group comprising an odometer reading, fuel level, engine status, vehicle speed, vehicle location, system pressure, vehicle emissions, vehicle power status, vehicle idle status, engine diagnostic trouble codes, vehicle acceleration and vehicle engine parameters.

7. A system according to claim 1, further comprising one or more service provider modules on one or more service provider computer systems; said telemetry module adapted to communicate with said one or more service provider computer systems, whereby a service provider carries out said action initiated by said telemetry module.

8. A system according to claim 1, further comprising a data collection terminal located proximate a location where said one or more vehicles in the fleet of vehicles is parked.

9. A system according to claim 8, wherein said data collection terminal includes wireless data communication means for communication with said control unit, and wherein said data collection terminal is adapted to collect data from said data collection unit.

10. A system according to claim 8, wherein said wireless data communication means includes radio frequency communication.

11. A system according to claim 1, wherein said action initiated by said telemetry module is a maintenance action.

12. A system according to claim 11, wherein said maintenance action is a conditional maintenance action

13. A method for managing a fleet of vehicles comprising:
providing a control unit on one or more vehicles in the fleet of vehicles;
providing a data collection unit on one or more vehicles in the fleet of vehicles in communication with said control unit;
receiving data from one of said control unit and said data collection unit and storing said data on an operational database;
accessing said operational database via a telemetry module;
initiating an action based on an analysis of data on said operational database.

14. A method according to claim 13, wherein said telemetry module is provided on said server.

15. A method according to claim 13, wherein said telemetry module is provided on a computer system in wireless communication with said server.

16. A method according to claim 13, further comprising providing one or more sensors on said one or more vehicles in the fleet of vehicles; said one or more sensors in communication with said control unit.

17. A method according to claim 16, further comprising measuring at least one vehicle parameter with said at least one sensor.

18. A method according to claim 17, wherein said at least one vehicle parameter is selected from the group comprising an odometer reading, fuel level, engine status, vehicle speed, vehicle location, system pressure, vehicle emissions, vehicle power status, vehicle idle status, engine diagnostic trouble codes, vehicle acceleration and vehicle engine parameters.

19. A method according to claim 13, further comprising providing one or more service provider modules on one or more service provider computer systems; said telemetry module adapted to communicate with said one or more service provider computer systems; and wherein said step of initiating is carried out by said one or more service provider modules.

20. A method according to claim 13, further comprising providing a data collection terminal proximate a location where said one or more vehicles in the fleet of vehicles is parked.

21. A method according to claim 20, wherein said data collection terminal includes wireless data communication means for communication with said control unit, and said method further comprises collecting data at said data collection terminal from said data collection unit.

22. A method according to claim 13, wherein said action initiated by said telemetry module is a maintenance action.

23. A method according to claim 22, wherein said maintenance action is a conditional maintenance action.
